(19) United States
(12) Patent Application Publication
(10) Pub. No.: US 2025/0377645 A1
(43) Pub. Date: Dec. 11, 2025

(54) MULTI-RECEIVER DISTRIBUTED PEN MAPPING

(71) Applicant: TidalX AI Inc., Mountain View, CA (US)

(72) Inventors: Harrison Pham, Sunnyvale, CA (US); Kathy Sun, Boulder Creek, CA (US); Thomas Robert Swanson, Sunnyvale, CA (US)

(21) Appl. No.: 19/300,911

(22) Filed: Aug. 15, 2025

Related U.S. Application Data
(63) Continuation of application No. PCT/US2024/016914, filed on Feb. 22, 2024.
(60) Provisional application No. 63/486,540, filed on Feb. 23, 2023.

(51) Int. Cl. G05B 17/02; A01K 61/60

(52) U.S. Cl. CPC G05B 17/02; A01K 61/60

(57) ABSTRACT

Methods, systems, and apparatus, including computer programs encoded on computer storage media, for fishery net management. One of the methods includes transmitting, by an emitter, a signal; receiving, by each of multiple sensors located at different, predetermined positions on a semi-rigid structure, the signal; determining, by each of the multiple sensors, timing information for the signal; determining, using the timing information for each sensor, a current shape of the semi-rigid structure; and controlling an item of equipment based on the current shape of the semi-rigid structure.

### CROSS REFERENCE TO RELATED APPLICATIONS

This application is a continuation and claims priority of International Application No. PCT/US2024/016914, filed Feb. 22, 2024, which claims the benefit of U.S. Provisional Application 63/486,540, filed on Feb. 23, 2023, the entire contents of which are incorporated herein by reference.

### TECHNICAL FIELD

The present specification relates to modeling rigid or semi-rigid structures using sensor data.

### BACKGROUND

People can use nets for many reasons in marine environments. For example, fish nets are used in open-ocean fish farms, to contain the fish and the equipment used to care for the fish.

Fish nets can be flexible or semi-rigid structures, and can move, flex, and change shape while being used. For example, during turbulent weather when underwater currents are strong, nets can move or change shape or position.

### SUMMARY

A net with sensors attached at known locations can monitor the relative positions of the sensors with respect to each other, so as to more accurately model the shape of the net, e.g., so that in-water equipment can be moved appropriately to avoid collisions with or damage to the net. For example, a net with embedded hydrophones at fixed intervals or at predefined stations can coordinate with an emitter to map the shape and movement of a net. The net can incorporate any number of sensors and emitters throughout the net such that a system could model the shape and movement of the net.

This system can utilize sensors throughout the net to map the shape and position of different portions of the net in order to inform operators and automated controllers for other pieces of equipment in order to avoid collision with the net. A generated model of the net can provide important information to the farmers and researchers involved with the fishery. For example, a farmer could view a model of the net and see whether tangles or twists exist within the net that may injure or harm the fish.

The ability to monitor the movement of a net through a system such as this can prevent the entanglement of equipment and other nets by alerting operators or controlling equipment associated with the net. For example, a camera that can move throughout the net to monitor fish can coordinate with the described monitoring system in order to move the camera out of the way of the net as the net moves in the ocean.

This can provide the benefit of being able to monitor the fish and equipment within and around net. The monitoring can lead to preventing the entanglement of the net with either the equipment or the net folding over itself and becoming tangled. These benefits can lead to a safer and more productive fishery.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment that can include a semi-rigid structure, a fishery net, with a number of sensors incorporated into fixed locations through the net.

FIG. 2 is an example of the components used for modeling a semi-rigid dynamic structure in fluid. The sensors can exist throughout the net in known and fixed locations.

FIG. 3 is an example process of determining the shape of a semi rigid structure and displaying it to a user.

Like reference numbers and designations in the various drawings indicate like elements.

### DETAILED DESCRIPTION

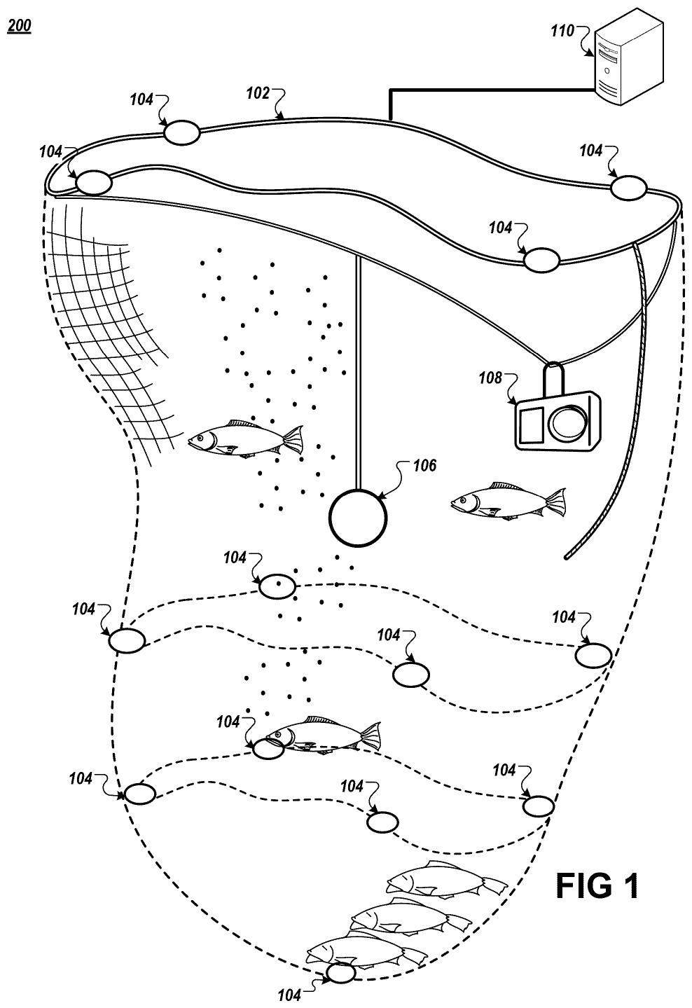

As shown in FIG. 1, marine environments utilizing nets can be particularly difficult for managing equipment that is used to support these nets. The ability to map the position of different portions of a semi-rigid or non-rigid dynamic structure through a fluid is beneficial to solving many types of problems.

Generally speaking, the system of FIG. 1, can map a likely 3D position of a semi rigid or non-rigid structure in fluid or gas. Through sensors distributed at predefined and fixed locations throughout the non-rigid structure, the system can determine the likely shape of the non-rigid structure. The system can use a transmission to the sensors from a predefined location and calculate based on the time of arrival of the transmission at the sensors, the position of each sensor throughout the structure. With the predefined position of the sensors embedded in fixed and predefined locations within the structure the system can utilize algorithms to map and predict the material of the structure between the sensor locations in order to develop a 3D model of the structure. The rate at which the sensors are activated by the signal and the number of sensors within the structure can determine the accuracy or resolution of the model.

In more detail, FIG. 1 is an example environment 100 that can include a semi-rigid structure, specifically a fishery net 102, with a number of sensors 104 incorporated into fixed locations through the net 102. The net 102 can include one or more sensors 104 incorporated into the net 102 at predefined locations. The environment 100 can include an emitter 106 that can be used to send a signal to the sensors 104, a camera 108 used to monitor the fish or the net, anchor points to stabilize portions of the net 102, and fish.

The net 102 can be of various sizes and shapes (e.g., circular, rectangular, cylindrical, or more). The net 102 can incorporate the sensors 104 into the net 102 in several ways for example, the sensors can stitch into the net a fixed intervals to create rings through-throughout the length of the net 102. Other attachments include, but are not limited to crimped cabling, tied in, chained, woven, or linked. In other examples, the net 102 can have the sensors 104 in the eight corners of a cube shaped net 102. In still other examples, the sensors 104 can be distributed in a spiral down through the net 102. The net 102 can be made of various materials and have various configurations for attaching the sensors 104. For instance, the net 102 can have additional sensors 104 at key parts of the net 102 such as the bottom, connection points, predefined areas in which the camera 108 operates, where other equipment such as the feeder is located. The additional sensors 104 in the net 102 can aid the system in mapping areas of the net 102 that can require additional resolution.

The sensors 104 in the net 102 can exist in various numbers and types. The sensors 104 can be all of one type such as hydrophones or of various types such as cameras, salinity sensors, depth sensors, temperature sensors, pressure sensors, and more. The sensors 104 can attach to the net 102 in various ways. The sensors 104 can all be connected through wiring that is intertwined with the net 102. The sensors 104 can communicate wirelessly, or through hydrophones. The sensors 104 can network together, such that the data transmitted from the furthest sensor 104 from the emitter travels through the other sensors 104. The number and location of the sensors 104 can vary. For instance, a net 102 which ends at a single point (as in FIG. 1), can have one sensor 104 at the bottom of the net and rings of sensors from the bottom of the net 102 towards the top. The sensors 104 receive signals from the emitter 106. More sensors can possibly increase the resolution of the mapping. Fewer sensors can require the system to interpret additional data and account for more variables, thereby increasing the time to create the model. An appropriate balance of sensors and the correctly locations of sensors can increase the speed and efficiency of the mapping.

The emitter 106 can emit a signal to the sensors 104 in order to map the sensor 104 locations. The emitter 106 can be in or outside of the net 102. The one or more emitters 106 can coordinate to determine the shape of the net 102. The emitters 106 can be located vertically separated such that one emitter corresponds to one ring of sensors 104. Two emitters 106 can be located near each other, but can emit different frequencies and thus help distinguish the received signal at the sensors 104. Emitters 106 can be located in several locations around the exterior of one or more nets 102. The emitter 106 position can depend on the shape of the net 102, the location of the sensors 104, and more. In some instances, the emitter 106 can move throughout the net 102 or be removed from the net 102 temporarily. The emitter 106 can be removed from the net for service, or when the emitter 106 is not needed by the system. The emitter 106 can be a hydrophone, light, or more. The emitter 106 can coexist as part of the camera 108 or be on the same mounting as the camera 108. The emitter 106 can have two or more emitters incorporated at fixed and predefined distances from each other. The emitter 106 and sensor 104 positions and design can facilitate the calculation of both range and bearing of the sensors from the emitter using constraints within the system or transducer design.

The camera 108 can be mounted into the net 102 in such a way as to monitor the fish or the net 102. The camera 108 can move throughout the net and observe portions of the net 102 for damage, monitor the health of the fish, monitor the sensors 104 and emitter 106 for damage and more. The camera 108 can verify the 3D model of the net created by the system and can contribute visual data to aid in the 3D modelling of the net 102. The camera 108 can move vertically up and down the net 102. The camera 108 can be removed from the net 102 in response to detecting a near collision or when the camera 108 is not needed. The camera 108 can also monitor other equipment in the net 102 such as the fish feeder.

Additional examples include the use of multiple sensor types to determine the shape of the net. For instance, depth sensors can provide the z-axis values of depth of each sensor 104 in the net, while the system can use the transmission time of the signal between the emitter 106 and sensors 104 to determine the x and y-axis components of the net 102.

In other examples unique shapes of emitters or sensors can aid in the system analysis of the net 102 shape. For instance, one continuous string of hydrophones from the top of the net 102 to the bottom can provide a very accurate representation of the edge of the net 102. The spacing of the hydrophones in the continuous sensor 104 could provide data for points every inch along the sensor 104. In this example, the system could minimize the use of computational power to statistically analyze the space between sensors points that could be spread throughout the net 102.

In some implementations the system can contain values representing the constraints of the semi-rigid structure. The constraints can aid in the modeling of the semi-rigid structure by providing limitations to the semi-rigid structure. When the constraints and predefined positions of the sensors are combined, the system can more readily approximate the model of the semi-rigid structure. For instance, the if two sensors 104 have the same arrival time for the emitted energy, and the system knows that the two sensors 104 are in fixed positions within the semi-rigid structure, then the probabilistic scenario is that the portion of the semi-rigid structure has folded over itself such that the sensors 104 overlap. Several factors can contribute to the constraints including, but not limited to the shape of the semi-rigid structure, the number of sensors 104, the placement of sensors 104, the number of emitters 106, and the location of the one or more emitters 106.

In some implementations the system can use the time that the emitter 106 produced the emitted energy with the arrival time of the emitted energy at the sensors 104 to produce the model of the semi-rigid structure. For example, the system can use the emitted energy time and the arrival time of the emitted energy to know the distance and calculate the location of the sensors throughout the semi-rigid structure. The system can operate with the emitted energy originating from within our without the semi-rigid structure, and can use the time of emission to calculate and create the model of the semi-rigid structure.

In some implementations the system can use the arrival time of the emitted energy at the sensors 104 combined with physical constraints of the semi-rigid structure in order to calculate a best fit solution for the model. For example, the system can received arrival time data for the emitted energy for three sensors 104. The three sensors 104 can all exist in line with each other along a single side of the semi-rigid structure. Each arrival time limits the modelling of successive portions of the semi-rigid structure. In this example, the first sensors is bound by a physical constraint in that where it is attached to the semi-rigid structure is physically limited to be within a set distance of both the emitter and the other sensors. Therefore, as the system receives each arrival time of the emitted energy at the sensors 104, the solution is constrained by how the sensors 104 are physically located throughout the semi-rigid structure.

In some implementations the emitter 106 can have a spherical array of transducers such that emissions can travel down particular bearings. Additionally, the use of transducers can allow for the position of emitter 106 and sensors 104 to be reversed. For example, the spherical transducer array can receive emissions from emitters in the net.

In some implementations both the sensors 104 and the emitter 106 are transducers and can act to either receive a signal or transmit a signal. For instance, with each sensors 104 throughout the net having the ability to emit a signal, the system can roll call each sensor 104 throughout the net and receive all the individual transmissions at the emitter 106.

In some implementations the system can utilize calibration routines to determine the location of portions of the semi-rigid structure, sensors 104, and emitters 106. For example, a system can have a predefined number of sensors 104 in the semi-rigid structure at fixed locations such as a floating portions of the semi-rigid structure, anchor points, or more. These predefined sensor locations can coordinate with one or more emitters 106 to calibrate the system periodically, on a schedule, or as needed. Calibration routines can perform manually by a user or automatically by the system.

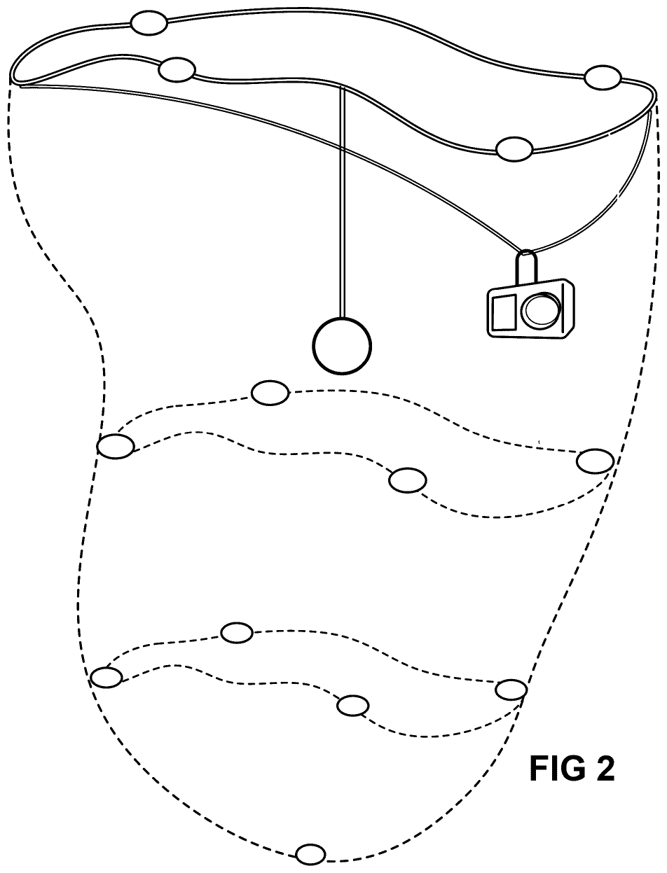

FIG. 2 is an example of the components used for modeling a semi-rigid dynamic structure in fluid. The sensors 104 can exist throughout the net in predefined and fixed locations. The emitter 106 location is either predefined in relation to key points of the net 102 or a second emitter 106 can be utilized. The emitter 106 emits a first signal that is received by the sensors 104 throughout the net at different times. The system can account for salinity and temperature differences through the fluid. When all signals are received at the various sensors 104, the data is transmitted back to the system 110. The system 110 can utilize various computer methods to compute the arrival times of the emitter 106 signal at the sensors 104 to calculate the shape of the net 102.

The emitter 106 can emit a first signal to the sensors 104. For example, an emitter 106, a hydrophone, located at the center of the rigid ring at the top of the net 102 can emit a single pulse or signal. The signal can travel and arrive at each sensors 104 at a different time. The emitter 106 can emit two pulses, a pulse that is phase shifted, or a pattern of pulses to either increase reception resolution at the sensors 104 or distinguish the received pulse at the sensors 104 in order to identify one net 102 from another net. The emitter 106 can also operate at different frequencies depending on the environment and the need to de-conflict pulses with other nets.

The sensors 104 can receive the pulse or signal from the emitter 106. The sensors 104 can timestamp the received pulse and record data such as frequency, pressure, signal strength, temperature, salinity, and more. The sensors 104 can transmit the data back to the system 110 in several ways. The sensors 104 can network together to transmit data, or connected through wires, or each independently connected through a dedicated wire, or any combination thereof. The packaging of the data can vary based on system 110 needs. For instance, the sensors 104 can parse the data such that only the time stamp from each sensors 104 is included in the data stream separated by commas. When received at the system 110, the system 110 can determine the received order of timestamps to be the physical layout of the sensors 104, thus distinguishing one sensor 104 from another. In other instances, the sensors 104 can transmit data that includes information that identifies the sensors 104 from other sensors such that the system 110 can determine which sensors the data is from. The system 110 can receive data from the sensors 104.

The system 110 receives the signals and processes the data from the sensors 104. The system 110 can employ several methods to interpret the data. For example, a system 110 can employ artificial intelligence (AI), neural networks, modelling algorithms, graphing algorithms, or more in order to present a representation of the semi-rigid structure. In some examples, the output of system 110 can be interpreted by other machines in order to move equipment in order to avoid collision. In other instances, the output is transmitted to users with reports on the net 102 status.

The process can include a time synchronization between components. The components can require very precise timing and therefore may require a calibration or initialization of the clocks between components. For example, the emitter 106 can emit energy that is received by the sensors 104. The system can measure the time-of-flight of the emitted energy. The emitter 106 and sensors 104 can establish timestamps for both the emitted and received energies. Some implementations can include clock synchronization methods similar to Network Time Protocol (NTP). Various other methods can be used to synchronize clocks. The synchronization may occur at install, startup, periodically, on a schedule, or any combination thereof.

The process can occur on a schedule, on demand, in response to detecting an event within or around the net. In some instances, the sampling frequency increases base inclement weather in the area. In other instances, users can set the sampling frequency in response to the needs of the user.

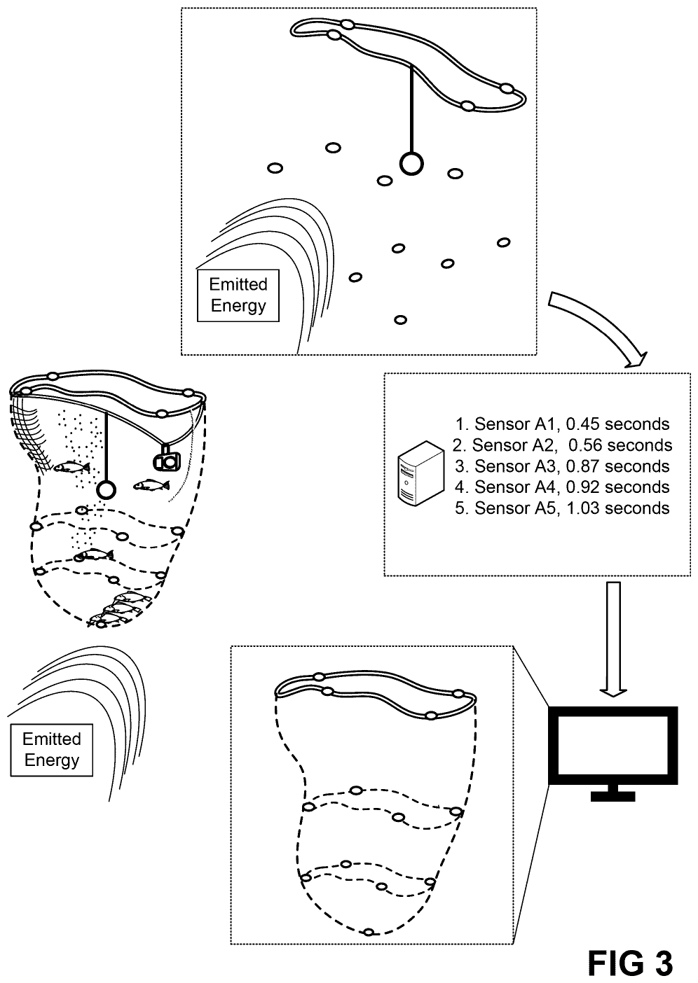

FIG. 3 is an example process of determining the shape of a semi rigid structure and displaying it to a user. The process involves the emission of energy from either the emitter 106 or from another source. The sensors 104 then receive the emitted energy and record and transmit the data to the system 110. The system 110 then receives the data from the sensors 104 and processes it to develop a model representing the semi-rigid structure. The model of the semi rigid structure is then displayed to a user.

The process involves the emission of energy from either the emitter 106 or from another source. In some instances, the emission of energy can occur from within the semi-rigid structure or from outside the semi-rigid structure. The emitted energy can have variable power, frequencies, repeated or non-repeated signals, or other waveform shaping characteristics. The system can utilize various strategies to allow multiple emissions to be distinguished from one another.

Sensors 104 then receive the emitted energy and record and transmit the data to the system 110. The sensors 104 can have directional features that can allow for the sensor 104 to determine the direction of arrival of the energy. In some examples, the sensors 104 have enough length to measure the curvature of the arriving energy wave. In these examples, the sensor can determine the arrival direction based on the difference in arrival times from one end of the sensor to the other. In other examples, the sensors can have an X shape that can allow for further wave form curvature analysis and directionality determination.

The system 110 then receives the data from the sensors 104 and processes it to develop a model representing the semi-rigid structure. The system 110 can utilize multiple methods to determine the representation of the semi-rigid structure. For example, using the predefined location of the sensors and the time of arrival, the system can use an existing and predefined model of the semi-rigid structure that includes accurate dimensions and shapes. With the existing model and the data from the sensors, the system 110 can run a statistical algorithm to determine the shape of the semi-rigid structure. In other examples, the system 110 can receive additional data from the sensors including depth, salinity, or more. The additional data provided to the system 110 can aid in developing the model of the semi-rigid structure using the combined data. The system 110 can use AI, Neural networks, remote processing through cloud computing, multiple processors, or more to aid in determining the model of the semi-rigid structure.

The model of the semi rigid structure is then displayed to a user. The model of the semi-rigid structure can be a 3D model, a plot of points, a mathematical representation, or more. The system can provide the model in a visual format for users to see and understand the shape of the semi-rigid structure. For example, the model can display in virtual or augmented reality, through mobile device screens, laptop or desktop computers, televisions, or any other manner in which to display a visual representation to a user. In other examples, the system can use the model to take action such as alert a user, move equipment out of the way of the net, or trigger other events to occur.

A number of implementations have been described. Nevertheless, it will be understood that various modifications may be made without departing from the spirit and scope of the disclosure. For example, various forms of the flows shown above may be used, with steps re-ordered, added, or removed. The semi-rigid and rigid structures are used as an example and be any form of structure including rigid structures.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

In general, one aspect of the subject matter described in this specification can be embodied in methods that include the actions of transmitting, by an emitter, a signal; receiving, by each of multiple sensors located at different, predetermined positions on a semi-rigid structure, the signal; determining, by each of the multiple sensors, timing information for the signal; determining, using the timing information for each sensor, a current shape of the semi-rigid structure; and controlling an item of equipment based on the current shape of the semi-rigid structure.

In some implementations, timing information for the signal comprises: a sensor identification; a signal type; and a time of arrival of the signal type.

Some implementations include: using the determined shape of the semi-rigid structure, generating a model of the semi-rigid structure; and providing for display to a user device, the model of the semi-rigid structure.

Some implementations, include: receiving data from the sensors indicating environmental conditions; using the data from the sensors indicating environmental conditions and the received signals, predicting a future shape of the semi-rigid structure; and controlling the item of equipment based on the predicted future shape of the semi-rigid structure.

In some implementations, determining, using the timing information for each sensor, a current shape of the semi-rigid structure includes: using a first model, representing the shape of the semi-rigid structure, that includes the location of each sensor with relation to each other sensor, generating a second model that represents the current shape of the semi-rigid structure.

Some implementations, include: receiving data indicating locations of sensors, relative to each other; receiving data indicating a time of arrival of a signal at the sensors; and generating, using the data indicating the location of the sensors and the data indicating the time of arrival of the signal at the sensors, a model representative of the location of each of the sensors.

Some implementations, include: using the generated model, providing for display an image representative of the location of the sensors in 3D space.

Some implementations, include: determining, using the generated model, whether the sensors are likely to collide with equipment; and in response to the determination, controlling one or more pieces of equipment to move such that the collision is less likely.

In some implementations, the sensors are coincidental with a semi-rigid structure.

Some implementations, include: emitting, from a known location, a signal receivable by the sensors.

Particular implementations of the invention have been described. Other implementations are within the scope of the following claims. For example, the steps recited in the claims, described in the specification, or depicted in the figures can be performed in a different order and still achieve desirable results. In some cases, multitasking and parallel processing may be advantageous.

1. A computer-implemented method comprising:
transmitting, by an emitter, a signal;
receiving, by each of multiple sensors located at different, predetermined positions on a semi-rigid structure, the signal;
determining, by each of the multiple sensors, timing information for the signal;
determining, using the timing information for each sensor, a current shape of the semi-rigid structure; and
controlling an item of equipment based on the current shape of the semi-rigid structure.

2. The method of claim 1, wherein the timing information for the signal comprises:
a sensor identification;
a signal type; and
a time of arrival of the signal type.

3. The method of claim 1, comprising:
using the determined shape of the semi-rigid structure, generating a model of the semi-rigid structure; and
providing for display to a user device, the model of the semi-rigid structure.

4. The method of claim 1, comprising:
receiving data from the sensors indicating environmental conditions;
using the data from the sensors indicating environmental conditions and the received signals, predicting a future shape of the semi-rigid structure; and
controlling the item of equipment based on the predicted future shape of the semi-rigid structure.

5. The method of claim 1, wherein determining, using the timing information for each sensor, a current shape of the semi-rigid structure comprises:
using a first model, representing the shape of the semi-rigid structure, that includes the location of each sensor with relation to each other sensor, generating a second model that represents the current shape of the semi-rigid structure.

6. A computer-implemented method comprising:
receiving data indicating locations of sensors, relative to each other;
receiving data indicating a time of arrival of a signal at the sensors; and
generating, using the data indicating the location of the sensors and the data indicating the time of arrival of the signal at the sensors, a model representative of the location of each of the sensors.

7. The method of claim 6, comprising:
using the generated model, providing for display an image representative of the location of the sensors in 3D space.

8. The method of claim 6, comprising:
determining, using the generated model, whether the sensors are likely to collide with equipment; and
in response to the determination, controlling one or more pieces of equipment to move such that the collision is less likely.

9. The method of claim 6, wherein, the sensors are coincidental with a semi-rigid structure.

10. The method of claim 6, comprising:
emitting, from a known location, a signal receivable by the sensors.

11. A system comprising one or more computers and one or more storage devices on which are stored instructions that are operable, when executed by the one or more computers, to cause the one or more computers to perform operations comprising:
transmitting, by an emitter, a signal;
receiving, by each of multiple sensors located at different, predetermined positions on a semi-rigid structure, the signal;
determining, by each of the multiple sensors, timing information for the signal;
determining, using the timing information for each sensor, a current shape of the semi-rigid structure; and
controlling an item of equipment based on the current shape of the semi-rigid structure.

12. The system of claim 11, wherein the timing information for the signal comprises:
a sensor identification;
a signal type; and
a time of arrival of the signal type.

13. The system of claim 11, comprising:
using the determined shape of the semi-rigid structure, generating a model of the semi-rigid structure; and
providing for display to a user device, the model of the semi-rigid structure.

14. The system of claim 11, comprising:
receiving data from the sensors indicating environmental conditions;
using the data from the sensors indicating environmental conditions and the received signals, predicting a future shape of the semi-rigid structure; and
controlling the item of equipment based on the predicted future shape of the semi-rigid structure.

15. The system of claim 11, wherein determining, using the timing information for each sensor, a current shape of the semi-rigid structure comprises:
using a first model, representing the shape of the semi-rigid structure, that includes the location of each sensor with relation to each other sensor, generating a second model that represents the current shape of the semi-rigid structure.

16. A system comprising one or more computers and one or more storage devices on which are stored instructions that are operable, when executed by the one or more computers, to cause the one or more computers to perform operations comprising:
receiving data indicating locations of sensors, relative to each other;
receiving data indicating a time of arrival of a signal at the sensors; and
generating, using the data indicating the location of the sensors and the data indicating the time of arrival of the signal at the sensors, a model representative of the location of each of the sensors.

17. The system of claim 16, comprising:
using the generated model, providing for display an image representative of the location of the sensors in 3D space.

18. The system of claim 16, comprising:
determining, using the generated model, whether the sensors are likely to collide with equipment; and
in response to the determination, controlling one or more pieces of equipment to move such that the collision is less likely.

19. The system of claim 16, wherein, the sensors are coincidental with a semi-rigid structure.

20. The system of claim 16, comprising:
emitting, from a known location, a signal receivable by the sensors.
